(19) United States
(12) Patent Application Publication
(10) Pub. No.: US 2024/0331189 A1
(43) Pub. Date: Oct. 3, 2024

(54) OBJECT DETECTION DEVICE AND OBJECT DETECTION SYSTEM

(71) Applicant: Mitsubishi Electric Corporation, Tokyo (JP)

(72) Inventors: Genki TANAKA, Tokyo (JP); Takuya TANIGUCHI, Tokyo (JP); Yohei KAMEYAMA, Tokyo (JP)

(73) Assignee: Mitsubishi Electric Corporation, Tokyo (JP)

(21) Appl. No.: 18/421,211

(22) Filed: Jan. 24, 2024

(30) Foreign Application Priority Data
Mar. 28, 2023 (JP) 2023-050934

(51) Int. Cl. G06T 7/70; G06T 7/20; G06T 7/62; G06V 20/54; G06V 20/60

(52) U.S. Cl. CPC G06T 7/70; G06T 7/20; G06T 7/62; G06V 20/54; G06V 20/60

(57) ABSTRACT

Provided is an object detection device that can estimate an object position from a 2D-BBOX, with high accuracy. The object detection device includes: an object extraction unit which extracts an object from an image and outputs a rectangle enclosing the object in a circumscribing manner; a direction calculation unit which calculates a direction of the extracted object on the image; and a bottom area calculation unit which calculates bottom areas of the object on the image and in a real world coordinate system, using a width of the rectangle outputted from the object extraction unit and the direction of the object on the image calculated by the direction calculation unit.

### BACKGROUND OF THE INVENTION

### 1. Field of the Invention

The present disclosure relates to an object detection device and an object detection system.

### 2. Description of the Background Art

In recent years, automated driving technologies for automobiles have been increasingly developed. For achieving automated driving, it is proposed that a road side unit is provided for detecting an object in an area and sending detected object information to a vehicle, a person, a dynamic map, and the like. The road side unit has sensors such as a light detection and ranging (LiDAR) device and a camera, detects an object from each sensor, calculates information such as the position and the type of the detected object, and sends the information.

For example, in a situation in which an automated driving vehicle overtakes another vehicle, the automated driving vehicle needs to acquire the presence area of an object with high position accuracy (approximately 0.1 to 1 m) from object information detected by the road side unit. The presence area is, specifically, represented by a rectangular parallelepiped having information about “position”, “length, width, height”, and “direction” on a dynamic map. In a case where information about “height” is not important, the presence area is replaced with a bottom area, and the bottom area is represented by a rectangle having information about “position”, “length, width”, and “direction” on the dynamic map.

In a case where an object is detected from image information acquired by the road side unit, it is necessary to calculate the position of the detected object in the real world. In general, after an object is detected as a two-dimensional rectangle (2D bounding box, hereinafter referred to as 2D-BBOX) on an image, the coordinates of any position on the detected 2D-BBOX are transformed to coordinates in the real world using a homography matrix or an external parameter of a camera, whereby the position in the real world can be calculated. For example, Patent Document 1 proposes a method in which, using matching with a template image, shift of an image due to shake of a camera is corrected, and then real world coordinates are calculated, thereby enhancing position accuracy.

Non-Patent Document 1 describes a method for outputting a three-dimensional rectangular parallelepiped (3D bounding box, hereinafter referred to as 3D-BBOX) using a neural network model, in order to estimate the size and the direction of an object in an image.
Patent Document 1: Japanese Laid-Open Patent Publication No. 2022-34034
Non-Patent Document 1: Peixuan Li, Huaici Zhao, Pengfei Liu, Feidao Cao, “RTM3D: Real-time Monocular 3D Detection from Object Keypoints for Autonomous Driving”, arXiv preprint arXiv: 2001.03343, 2020

In the method described in Patent Document 1, in a case of calculating an object position from a 2D-BBOX, the center position or the lower-end center position of the 2D-BBOX is used as a representative position of the object and is transformed to that in the real world coordinate system. However, the center position of the actual object changes in accordance with the direction of the object in the image, and the object position transformed from the image by the above method does not reflect the center position of the actual object. Thus, position estimation accuracy is deteriorated.

In the method described in Non-Patent Document 1, in order to use a neural network that can output a 3D-BBOX, a large amount of annotation data of three-dimensional rectangular parallelepipeds is needed for training the neural network. For a 2D-BBOX, there are many existing methods for calculation thereof, and annotation therefor can be performed at small cost. However, for a 3D-BBOX, there is a problem that large cost is required for annotation and learning.

### SUMMARY OF THE INVENTION

The present disclosure has been made to solve the above problem, and an object of the present disclosure is to provide an object detection device that can estimate an object position from a 2D-BBOX, with high accuracy.

An object detection device according to the present disclosure is an object detection device which extracts an object from an image acquired by an imaging unit and calculates a position of the object in a real world coordinate system, the object detection device including: an object extraction unit which extracts the object from the image and outputs a rectangle enclosing the object in a circumscribing manner; a direction calculation unit which calculates a direction, on the image, of the object extracted by the object extraction unit; and a bottom area calculation unit which calculates bottom areas of the object on the image and in the real world coordinate system, using a width of the rectangle outputted from the object extraction unit and the direction of the object on the image calculated by the direction calculation unit. The bottom areas include positions, sizes, and directions of the object on the image and in the real world coordinate system, respectively.

According to the present disclosure, a bottom area of an object can be estimated with high accuracy from an acquired image, using a 2D-BBOX, whereby the object position can be estimated with high accuracy.

### BRIEF DESCRIPTION OF THE DRAWINGS

FIG. 1 is a block diagram showing the configuration of an object detection system according to the first embodiment of the present disclosure;

FIG. 2 is a function block diagram showing the configuration of an object detection device according to the first embodiment;

FIG. 3 shows a placement example of a road side unit and a detection range of the road side unit;

FIG. 4 shows an example in which an object is extracted in an image acquired by the road side unit;

FIGS. 5A and 5B illustrate a transformation example between image coordinates and real world coordinates, FIG. 5A showing an example of an acquired image and FIG. 5B showing an example of a dynamic map;

FIG. 6 illustrates a calculation method for a bottom area in the image coordinate system;

FIGS. 7A and 7B illustrate a calculation method from a bottom area in the image coordinate system to a bottom area in the real world coordinate system, FIG. 7A showing the image coordinate system and FIG. 7B showing the real world coordinate system;

FIGS. 8A and 8B show an example in which a bottom area of an object is calculated, FIG. 8A showing the bottom area on an image and FIG. 8B showing the bottom area on a dynamic map;

FIGS. 9A and 9B illustrate change in a bottom area in accordance with the direction of an object, FIG. 9A showing an example in which the direction of the object is an angle θ1 and FIG. 9B showing an example in which the direction of the object is an angle θ2;

FIGS. 10A and 10B illustrate conditions for the length of an object, FIG. 10A showing a bottom area of an object having a length Lpix1 and a width Wpix1 and FIG. 10B showing a bottom area of an object having a length Lpix2 and a width Wpix2;

FIG. 11 is a flowchart illustrating the procedure of object detection in the object detection device according to the first embodiment;

FIG. 12 is a function block diagram showing the configuration of an object detection device according to the second embodiment of the present disclosure;

FIG. 13 is a function block diagram showing the configuration of an object detection device according to the third embodiment of the present disclosure;

FIG. 14 illustrates an object direction map;

FIG. 15 is a flowchart illustrating the procedure of object detection in the object detection device according to the third embodiment;

FIG. 16 is a function block diagram showing the configuration of an object detection device according to the fourth embodiment of the present disclosure;

FIG. 17 shows an example of an object direction table;

FIG. 18 shows the hardware configuration of the object detection system and the object detection device according to each of the first to fourth embodiments; and

FIG. 19 shows another example of the hardware configuration of the object detection system and the object detection device according to each of the first to fourth embodiments.

### DETAILED DESCRIPTION OF THE PREFERRED EMBODIMENTS OF THE INVENTION

### First Embodiment

Hereinafter, an object detection system and an object detection device according to the first embodiment of the present disclosure will be described with reference to the drawings.

### <Configuration of Object Detection System>

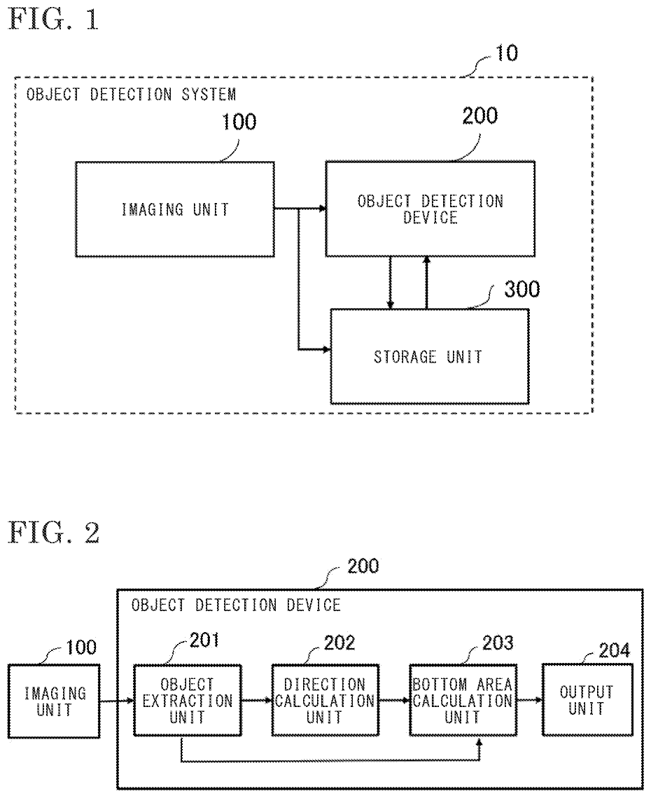

FIG. 1 is a block diagram showing the configuration of the object detection system according to the first embodiment. An object detection system 10 includes an imaging unit 100 which takes an image by means such as a camera provided to a road side unit, an object detection device 200 which extracts an object from the image taken by the imaging unit 100 and calculates the position, the size, and the facing direction (angle, orientation) of the object, and a storage unit 300 storing information needed for processing in the object detection device 200. The storage unit 300 includes one or a plurality of various storage devices such as a random access memory (RAM) and a read only memory (ROM), for example. The storage unit 300 also stores information such as an image taken by the imaging unit 100, and the position, the size, and the direction of the object calculated by the object detection device 200.

### <Configuration of Object Detection Device 200>

FIG. 2 is a function block diagram showing the configuration of the object detection device 200 according to the first embodiment. In FIG. 2, the object detection device 200 includes: an object extraction unit 201 which receives an image taken by the imaging unit 100 and extracts an object from the image; a direction calculation unit 202 which calculates the object facing direction, on the image, of the object extracted by the object extraction unit 201; a bottom area calculation unit 203 which calculates a bottom area of the object using an area of the object extracted by the object extraction unit 201 and the object direction information obtained from the direction calculation unit 202; and an output unit 204 which distributes the bottom area of the object calculated by the bottom area calculation unit 203. Hereinafter, the details of each unit will be described.

The imaging unit 100 transmits a camera image (hereinafter, simply referred to as “image”) taken by the camera provided to the road side unit RU, to the object extraction unit 201. Generally, images are taken at an interval of about several fps to 30 fps, and are transmitted by any transmission means such as a universal serial bus (USB), a local area network (LAN) cable, or wireless communication.

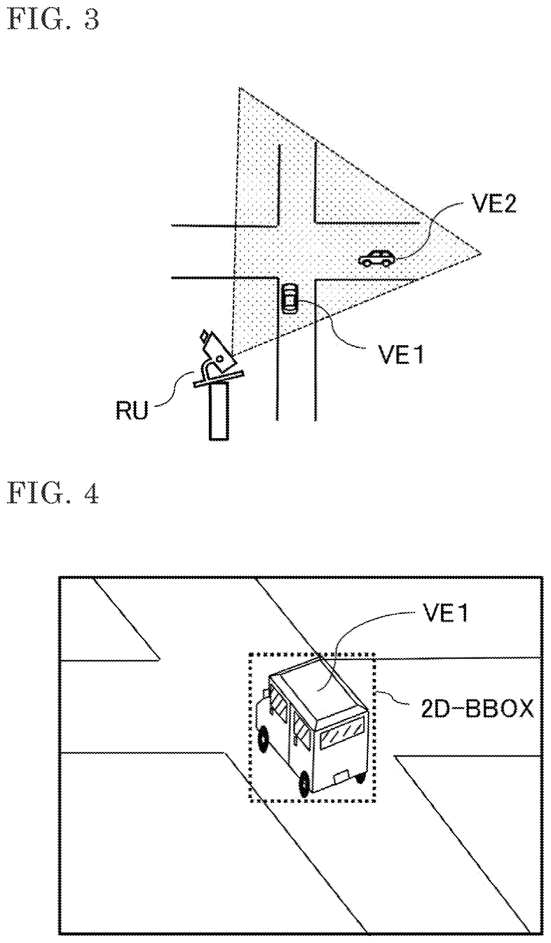

Here, an image taken by the imaging unit 100 will be described. FIG. 3 shows an example of the placement of the road side unit RU provided to the imaging unit 100 and the detection range of the road side unit RU. As shown in FIG. 3, the road side unit RU provided near an intersection has a camera provided at a certain height (e.g., 6 m) from the road surface so as to cover a desired detection range and look down obliquely from above objects. Here, the detection range where the camera takes an image is a radial area including the center of the intersection and is a dot-hatched area. A detection target object is an object that needs to be detected for automated driving, and is, for example, a vehicle, a person, etc. Objects that can be detected and detection accuracy depend on an algorithm and a model used in the object extraction unit 201, and the like. In FIG. 3, at a certain time, the road side unit RU is capturing two vehicles VE1, VE2 moving toward the intersection, in the imaging range. In the following description, position detection for the vehicle VE1, of the two vehicles VE1, VE2, will be described as an example.

The object extraction unit 201 acquires an image taken by the imaging unit 100 and outputs a rectangle enclosing an object in an image in a circumscribing manner by known means such as pattern matching, a neural network, or background subtraction. Here, in general, the image acquired from the imaging unit 100 is subjected to enlargement/reduction, normalization, and the like in accordance with an object extraction algorithm and an object extraction model used in the object extraction unit 201. In a case of using a neural network or the like, in general, the object type is also outputted at the same time, but is not necessarily needed in the present embodiment.

FIG. 4 shows an example in which the object extraction unit 201 extracts an object from an image taken by the road side unit RU. In the drawing, a dotted-line rectangle enclosing a vehicle VE1 which is the extracted object is a 2D-BBOX.

Regarding the object extracted by the object extraction unit 201, the direction calculation unit 202 calculates the direction in which the object faces (in a case of a vehicle, the direction in which the front side thereof faces). In the road side unit RU, the correspondence between image coordinates on the image and real world coordinates is known in advance, and therefore the direction in the image coordinate system and the direction in the real world coordinate system can be transformed to each other.

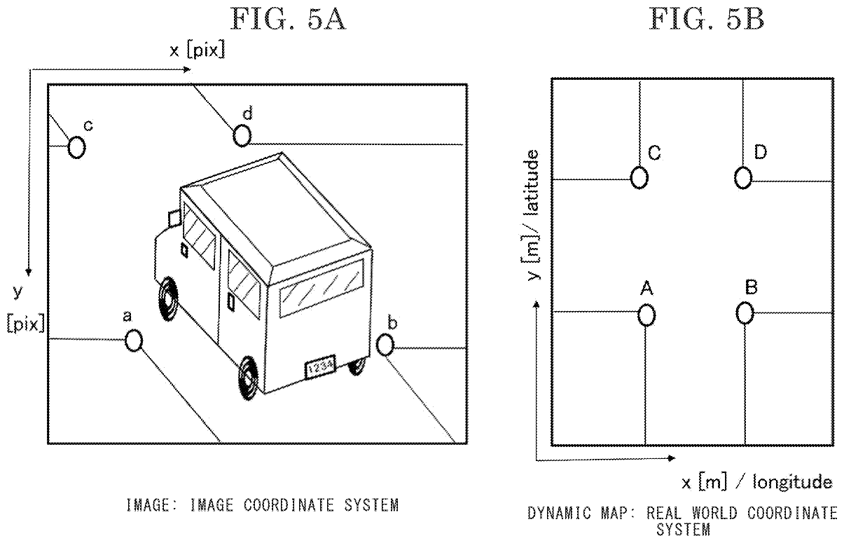

Here, transformation between image coordinates and real world coordinates will be described with reference to FIGS. 5A and 5B. In FIGS. 5A and 5B, FIG. 5A shows an acquired image and FIG. 5B shows, for example, a dynamic map. A coordinate system on the image is defined as image coordinate system, and a coordinate system on the dynamic map is defined as real world coordinate system. The dynamic map is a map that is referred to when the vehicle performs automated driving, and includes obstacle information and the like. It is assumed that outputs of the object detection system 10 and the object detection device 200 according to the present embodiment are used in automated driving, and therefore the dynamic map is used as a target of the real world coordinate system.

As shown in FIG. 5A, in general, the image coordinate system is defined using pixel (pix) as a unit, with the origin set at the upper left of the image, the right direction set as the positive direction of an x axis, and the downward direction set as the positive direction of a y axis. As shown in FIG. 5B, in general, the real world coordinate system is defined with an x axis set as a longitude, a y axis set as a latitude, and a z axis set as a height, or is defined as a coordinate system using meter as a unit, with an appropriate position set as the origin, the east direction set as the positive direction of an x axis, the north direction set as the positive direction of a y axis, and the height direction set as the positive direction of a z axis.

Since the camera of the road side unit RU is fixed, a transformation formula between image coordinates and real world coordinates is prepared in advance, whereby transformation can be performed therebetween as long as heights in the real world coordinate system are on the same plane. For example, with respect to points on the ground (height=0), when four sets (a, b, c, d) of image coordinates in FIG. 5A are associated with sets (A, B, C, D) of real world coordinates in FIG. 5B, a homography matrix M for performing transformation from image coordinates to real world coordinates can be calculated. Using an inverse matrix M⁻¹ of the homography matrix M, it is also possible to perform transformation from real world coordinates to image coordinates. The same transformation can be performed even by using a camera external parameter matrix defining the orientation (rotation, translation) of the camera, instead of the homography matrix, but in the following description, a case of using the homography matrix is shown as an example.

The direction calculation unit 202 calculates the direction of an object in the real world coordinate system on the basis of the above-described transformation between image coordinates and real world coordinates. The object direction may be defined in any manner. For example, in the image coordinate system, the direction may be defined in a range of 0 to 360° with the x-axis direction of the image set as 0° and the counterclockwise direction set as positive, and in the real world coordinate system, the direction may be defined in a range of 0 to 360° with the east direction (x-axis direction) set as 0° and the direction of rotation from east to north (y-axis direction) set as positive.

Also, the direction may be calculated in any method. For example, a history of the movement direction of the 2D-BBOX may be used. In this case, with respect to any position on the 2D-BBOX, e.g., the bottom center, a difference in the coordinates thereof between frames is taken, and the direction of the difference vector is used as the direction of the object in the image. The direction may be obtained using a known image processing algorithm such as direction estimation by a neural network or optical flow.

In a case where information from another sensor such as a LiDAR device or a millimeter-wave radar can be used, a direction obtained from the sensor may be used. The direction may be calculated using image information obtained from another camera placed at a different position. In a case where an extracted object is a vehicle, information from a global navigation satellite system (GNSS) sensor of the vehicle or speed information thereof may be acquired and used, if possible.

The bottom area calculation unit 203 calculates a bottom area of the object, using information of the 2D-BBOX which is a rectangle acquired from the object extraction unit 201 and the direction information of the object on the image calculated by the direction calculation unit 202.

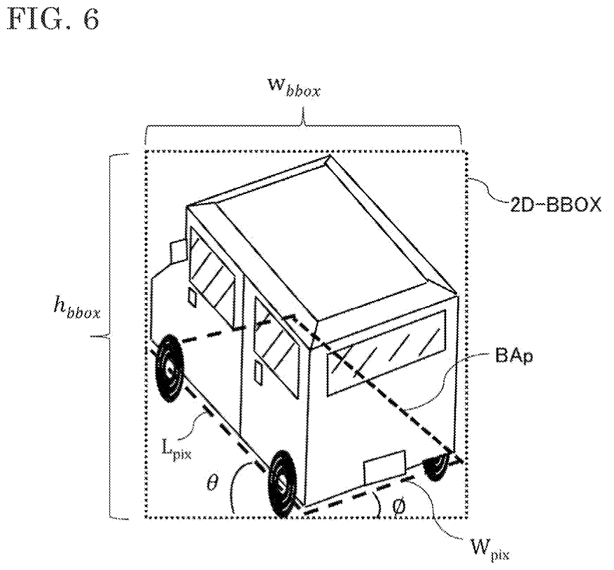

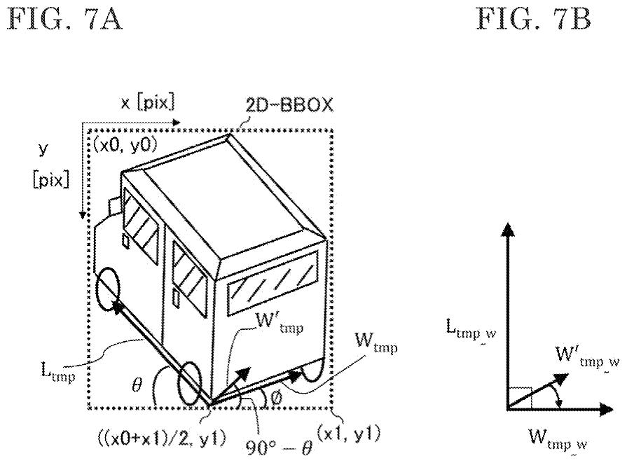

FIG. 6 illustrates a method for calculating a bottom area of an object in the image coordinate system, and FIGS. 7A and 7B illustrate a calculation method from the bottom area in the image coordinate system to a bottom area in the real world coordinate system. In FIGS. 7A and 7B, FIG. 7A shows the image coordinate system and FIG. 7B shows the real world coordinate system.

In the drawings, physical quantities are defined as follows.
wbbox: transverse width of 2D-BBOX
hbbox: longitudinal width of 2D-BBOX
Lpix: longitudinal width of object on image
Wpix: transverse width of object on image
ratio_pix: ratio (Lpix/Wpix) of longitudinal width and transverse width of object on image
θ: angle between Lpix and x axis
φ: angle between Wpix and x axis Next, the calculation procedure for the bottom area will be described.
1) In FIG. 7A, it is assumed that, at the lower end center (coordinates ((x0+x1)/2, y1)) of the 2D-BBOX, the object has the angle θ with respect to the x axis. The angle θ is an angle representing the direction of the object on the image estimated by the direction calculation unit 202.
2) In FIG. 7A, Ltmp and W′tmp are generated. Ltmp is a vector extending from the lower end center of the 2D-BBOX at the angle θ by a given length (e.g., half the height of the 2D-BBOX), and the given length is half the longitudinal length of the 2D-BBOX, for example. W′tmp is a vector extending from the lower end center of the 2D-BBOX at a given angle by a length Ltmp/ratio_w. The given angle is 90°-θ, for example. Here, the value of ratio_w is set in advance.
3) The vector Ltmp and the vector W′tmp are respectively transformed to a vector Ltmp_w and a vector W′tmp_w in the real world coordinate system, using the homography matrix M.
4) In the real world coordinate system in FIG. 7B, the vector W′tmp_w is rotated to be perpendicular to the vector Ltmp_w, and the length thereof is adjusted by being enlarged or reduced to be 1/ratio_w of Ltmp_w, thus obtaining a vector Wtmp_w.

That is, | Wtmp_w|=| Ltmp_w|/ratio_w is satisfied.

As described above, the ratio_w which is the ratio of the longitudinal width and the transverse width of the object in the real world coordinate system is set in advance.
5) The vector Wtmp_w is transformed by the inverse matrix M⁻¹ of the homography matrix, and the transformed vector is defined as a vector Wtmp.
6) In FIG. 7A, the ratio of the lengths of the vector Ltmp and the vector Wtmp is ratio_pix, and the angle between the vector Wtmp and the x axis is the angle φ.
7) In FIG. 6, the 2D-BBOX is represented by a rectangle enclosing the object in the image in a circumscribing manner and having sides parallel to the x axis. Thus, the transverse width wbbox of the 2D-BBOX can be represented by Expression (1). Expression (1) is solved for the transverse width Wpix of the object on the image, whereby the transverse width Wpix of the object and the longitudinal width Lpix (Lpix=Wpix×ratio_pix) of the object on the image can be calculated.

### [Mathematical 1]

$$wbbox = Lpix \times cos θ + Wpix \times cos ∅ = Wpix \times ratio\_pix \times cos θ + Wpix \times cos ∅ \qquad ( 1 )$$

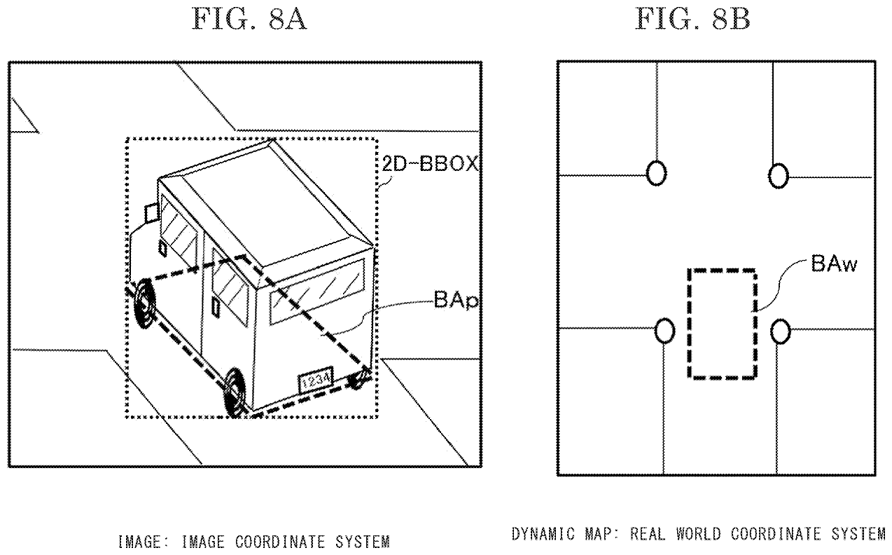

The output unit 204 outputs the bottom area of the detected object calculated by the bottom area calculation unit 203. FIGS. 8A and 8B show examples of the bottom area of the object calculated by the bottom area calculation unit 203. FIG. 8A shows a bottom area BAp by a broken-line rectangle in the image, and FIG. 8B shows a bottom area BAw by a broken-line rectangle in the dynamic map. These can be transformed to each other through homography transformation/inverse-transformation of vertices of the area. The format of the output is not limited to such a rectangle. For example, “positions of four vertices in the real world coordinate system” or “the position of the center (bottom area center), the transverse width, the longitudinal width, and the direction of the object in the real world coordinate system”, may be outputted.

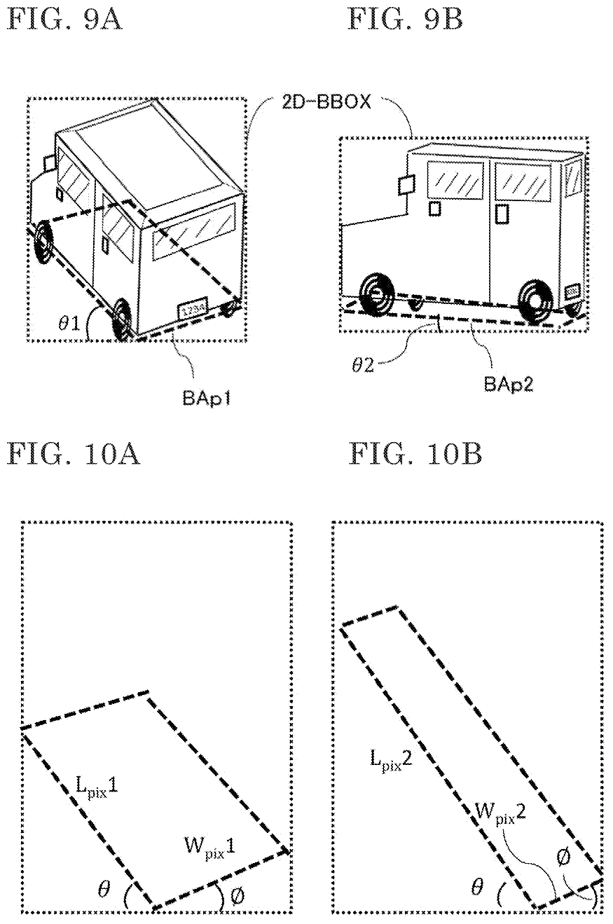

Conditions for the above calculation of the bottom area will be described. FIGS. 9A and 9B illustrate change in the bottom area in accordance with the direction of the object. FIG. 9A shows a bottom area BAp1 in a case where the direction of the object is an angle θ1 on the image, and FIG. 9B shows a bottom area BAp2 in a case where the direction of the object is an angle θ2 on the image. FIGS. 10A and 10B illustrate conditions for the length of the object. In FIGS. 10A and 10B, FIG. 10A shows an example of the bottom area in a case where the object has the angle θ with respect to the x axis at the lower end center of the 2D-BBOX, and FIG. 10B shows an example of the bottom area in a case where the object has the angle θ with respect to the x axis at a position away from the lower end center of the 2D-BBOX. In other words, FIGS. 9A and 9B show examples in which the same vehicle has different directions, and FIGS. 10A and 10B show examples in which vehicles having different sizes (lengths, widths) have the same direction.

Normally, the center coordinates are coordinates indicating the center position of the object. However, in the 2D-BBOX on the image, a position optimum as the center coordinates of the object changes in accordance with the position, the size, and the direction of the object and the position of the camera. For example, in a case of performing transformation to real world coordinates using the center of the 2D-BBOX as the object center, the direction of the object in FIG. 9B is the angle θ2 which is smaller than the angle θ1 of the object in FIG. 9A, and therefore the bottom area in the case of FIG. 9B cannot be acquired with high position accuracy in normal transformation by a homography matrix. In addition, the objects having the same angle θ shown in FIGS. 10A and 10B cannot be discriminated from each other without any condition, in transformation by a homography matrix.

In the present embodiment, by using the fact that the object has the angle θ with respect to the x axis at the lower end center of the 2D-BBOX and using the ratio ratio_w (=Ltmp_w/Wtmp_w) of the vector Wtmp_w and the vector Ltmp_w in the real world coordinate system, the bottom area can be estimated with high accuracy in transformation by a homography matrix, whereby the object position accuracy can be improved. That is, Expression (1) can be solved by using the “direction θ of the object” on the image, the “transverse width Wbbox of the 2D-BBOX”, and the “longitudinal-transverse ratio of the object in the real world coordinate system” as conditions. Also in the examples in which the same vehicle has different directions in FIGS. 9A and 9B and the examples in which the vehicles having different sizes (lengths, widths) have the same direction in FIGS. 10A and 10B, by using the above conditions, the bottom areas can be accurately estimated, whereby the object position can be accurately calculated.

In the image, if the angle θ of the object with respect to the x axis is at a position near the lower end center of the 2D-BBOX, the angle φ and the ratio ratio_pix of the longitudinal width and the transverse width of the object on the image, are hardly changed.

In a case of considering various types of vehicles as detected objects, for example, a truck and a passenger car are greatly different in longitudinal length, but their longitudinal-transverse ratios are assumed to be not greatly different. Therefore, in the present embodiment, the ratio ratio_w set in advance is used as the longitudinal-transverse ratio. The condition is not limited to the longitudinal-transverse ratio, and may be the longitudinal or transverse length of the object in the real world coordinate system.

For example, it is assumed that a “longitudinal length Lw of the object in the real world coordinate system” is already known or set.
1) The vector Ltmp and the vector W′tmp are respectively transformed to the vector Ltmp_w and the vector W′tmp_w in the real world coordinate system, using the homography matrix M, and then the length of the vector Ltmp_w is multiplied by Lw/| Ltmp_w|.
2) The vector W′tmp_w is rotated to be perpendicular to the vector Ltmp_w, to obtain the vector Wtmp_w.
3) The vector Ltmp_w and the vector Wtmp_w are transformed by the inverse matrix M⁻¹ of the homography matrix, to obtain a vector Ltmp_w_pix and a vector Wtmp_w_pix, respectively.
4) The vector Ltmp_w_pix is translated so that the distal end thereof contacts with the 2D-BBOX, and the resultant vector is used as the longitudinal width Lpix of the object on the image. The vector Wtmp_w_pix is translated by the same amount as the vector Ltmp_w_pix, and then the length thereof is adjusted so that the distal end of the vector Wtmp_w_pix contacts with the 2D-BBOX. The resultant scaled vector is used as the transverse width Wpix of the object on the image.

Also in a case where a “transverse length Ww of the object in the real world coordinate system” is already known or set, the longitudinal width Lpix and the transverse width Wpix of the object on the image can be calculated in the same manner.

These conditions are conditions regarding the “length of the object”.

### <Operation of Object Detection Device 200>

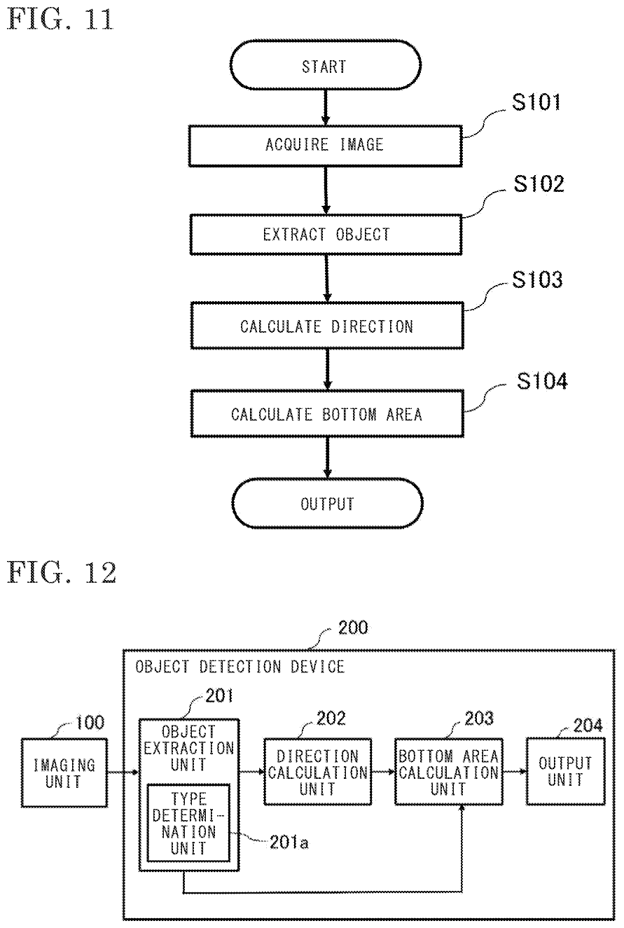

Next, the procedure of object detection in the object detection device 200 according to the first embodiment will be described with reference to a flowchart in FIG. 11. A process in the flowchart in FIG. 11 is repeatedly executed. Steps in FIG. 11 will be described in association with the function units shown in the function block diagram of the object detection device 200 in FIG. 2.

First, in step S101, the object extraction unit 201 acquires an image taken by the camera provided to the road side unit RU, from the imaging unit 100.

Next, in step S102, the object extraction unit 201 extracts an object from the image acquired from the imaging unit 100, and outputs a 2D-BBOX enclosing the object in a circumscribing manner.

Next, in step S103, the direction calculation unit 202 calculates the direction of the object on the image, using the 2D-BBOX outputted from the object extraction unit 201.

Next, in step S104, the bottom area calculation unit 203 calculates bottom areas of the object on the image and the dynamic map, using the 2D-BBOX outputted from the object extraction unit 201 and the direction of the object calculated by the direction calculation unit 202.

Finally, the output unit 204 outputs the bottom areas of the object calculated by the bottom area calculation unit 203.

Through the above operation, the object detection device 200 detects an object from an image acquired by the camera of the road side unit RU, and outputs information about the bottom area of the object including the position, the size (width, length), and the direction of the object.

As described above, according to the first embodiment, the object detection device 200 includes: the object extraction unit 201 which extracts an object from an image acquired by the imaging unit 100 and outputs a 2D-BBOX which is a rectangle enclosing the object in a circumscribing manner; the direction calculation unit 202 which calculates the direction θ, on the image, of the object extracted by the object extraction unit 201; and the bottom area calculation unit 203 which calculates the bottom area of the object on the image and the bottom area of the object in the real world coordinate system, using the width of the 2D-BBOX and the direction θ of the object on the image calculated by the direction calculation unit 202. In this configuration, transformation by the homography matrix is performed using the direction θ of the object on the image, and thus it is possible to adapt to change in the center position in accordance with the direction of the object. Therefore, as compared to the conventional configuration, the bottom areas of the object on the image and in the real world coordinate system can be accurately calculated, thus obtaining the object detection device 200 that can estimate the position, the size (width, length), and the direction of the object, with high accuracy.

The bottom area calculation unit 203 performs calculation processing using a condition for the “length of the object”, which is one of the “longitudinal length of the object”, the “transverse length of the object”, and the “longitudinal-transverse ratio of the object”. Thus, it becomes possible to calculate the bottom area of the object on the image and the bottom area of the object in the real world coordinate system while discriminating vehicles having the same direction and different sizes.

### Second Embodiment

Hereinafter, an object detection system and an object detection device according to the second embodiment of the present disclosure will be described with reference to the drawings.

The configuration of the object detection system according to the second embodiment is the same as that in FIG. 1 in the first embodiment, and the description thereof is omitted.

### <Configuration of Object Detection Device 200>

FIG. 12 is a function block diagram showing the configuration of the object detection device 200 according to the second embodiment. In FIG. 12, the object detection device 200 includes a type determination unit 201a in the object extraction unit 201, in the configuration in FIG. 2 in the first embodiment.

The object extraction unit 201 extracts an object from an image acquired by the imaging unit 100 and outputs a 2D-BBOX enclosing the object in a circumscribing manner, and also determines the type of the object by the type determination unit 201a. Here, the determination for the type of the object is determination among a standard vehicle, a large vehicle such as a truck, a motorcycle, a person, and the like, for example. The type determination unit 201a performs type determination by existing means such as an object detection model using a neural network. A trained model and the like used for type determination may be stored in the storage unit 300 included in the object detection system 10, and may be read when type determination is performed.

The direction calculation unit 202 calculates the object direction, on the image, of the object extracted by the object extraction unit 201, as in the first embodiment.

The bottom area calculation unit 203 calculates a bottom area of the object, using the 2D-BBOX of the object extracted by the object extraction unit 201 and the direction information of the object calculated by the direction calculation unit 202, as in the first embodiment. At this time, the bottom area is calculated using the “length of the object” and the “longitudinal-transverse ratio of the object” corresponding to the type of the object determined by the type determination unit 201a. For example, the longitudinal-transverse ratio is 3:1 for a standard vehicle, 4:1 for a large vehicle, and 1:1 for a person. Alternatively, the longitudinal length may be 3 m for a standard vehicle, 8 m for a large vehicle, and 1 m for a person. Such data associated with the types are stored in the storage unit 300 included in the object detection system 10, and are read by the bottom area calculation unit 203, to be used for calculation of a bottom area.

The output unit 204 outputs information about the bottom area of the object, including the position, the size (width, length), and the direction of the object, calculated by the bottom area calculation unit 203.

Thus, according to the second embodiment, the same effects as in the first embodiment are provided. In addition, the object extraction unit 201 includes the type determination unit 201a. Therefore, while an object is extracted from an image acquired by the imaging unit 100 and a 2D-BBOX enclosing the object in a circumscribing manner is outputted, the type of the object can be determined by the type determination unit 201a. Thus, the bottom area is calculated using the “length of the object”, the “longitudinal-transverse ratio of the object”, or the like that is based on the type of the object determined by the bottom area calculation unit 203, whereby the bottom area can be calculated with higher accuracy, so that accuracy of the estimated object position is improved.

### Third Embodiment

Hereinafter, an object detection system and an object detection device according to the third embodiment of the present disclosure will be described with reference to the drawings.

The configuration of the object detection system according to the third embodiment is the same as that in FIG. 1 in the first embodiment, and the description thereof is omitted.

### <Configuration of Object Detection Device 200>

FIG. 13 is a function block diagram showing the configuration of the object detection device 200 according to the third embodiment. In FIG. 13, the object detection device 200 includes an object direction map 202a, in the configuration in FIG. 2 in the first embodiment. The direction calculation unit 202 calculates the direction of an object by referring to the object direction map 202a.

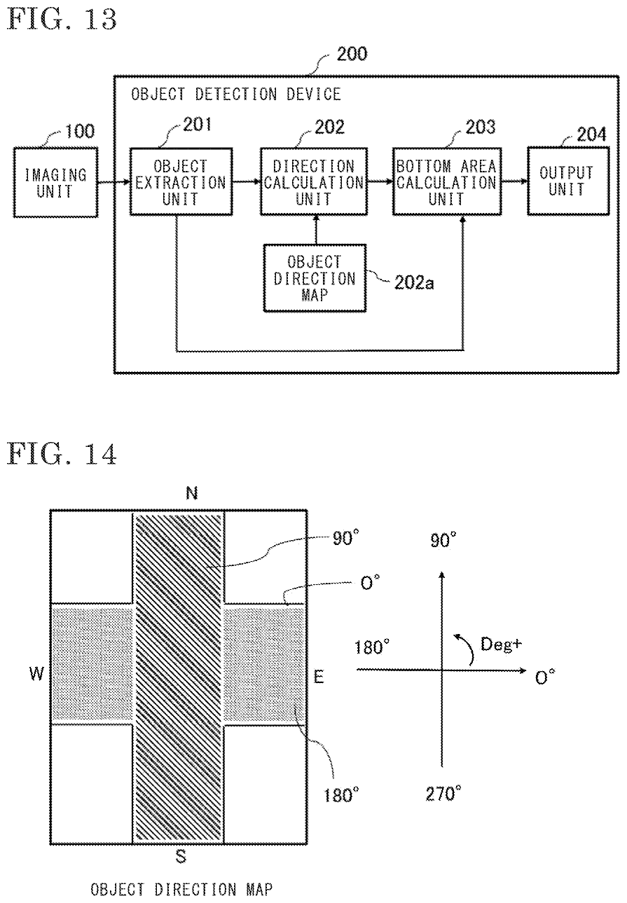

FIG. 14 illustrates the object direction map 202a. The object direction map 202a defines a direction of an object in accordance with the position of the object in the real world coordinate system. As shown in FIG. 14, for example, a direction is defined as 90° on a road extending in the north-south direction, and a direction is defined as 180° on a road extending in the east-west direction. In the third embodiment, any position on the 2D-BBOX is used as the center coordinates of the object and is transformed to a position in the real world coordinate system by a matrix M, and then the direction of the object corresponding to the position is acquired from the map, whereby the direction of the object is determined.

### <Operation of Object Detection Device 200>

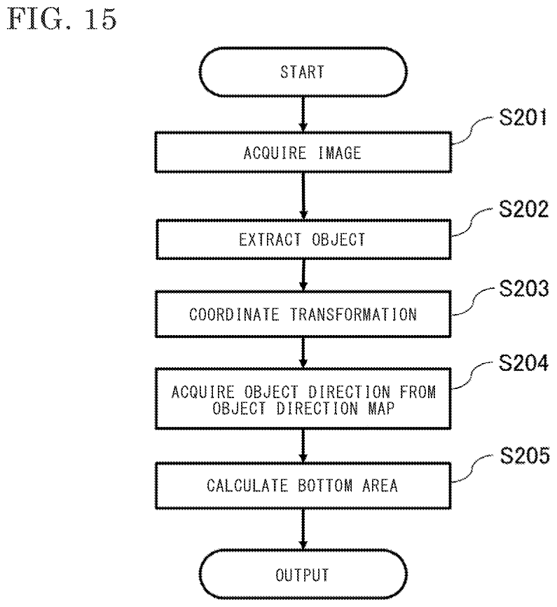

Next, the procedure of object detection in the object detection device 200 according to the third embodiment will be described with reference to a flowchart in FIG. 15. A process in the flowchart in FIG. 15 is repeatedly executed.

As in the first embodiment, first, in step S201, the object extraction unit 201 acquires an image taken by the camera provided to the road side unit RU, from the imaging unit 100, and in step S202, the object extraction unit 201 extracts an object from the image and outputs a 2D-BBOX enclosing the object in a circumscribing manner.

Next, in step S203, using the 2D-BBOX outputted from the object extraction unit 201, the direction calculation unit 202 sets any position such as the lower end center position of the 2D-BBOX and performs transformation from image coordinates to real world coordinates, as shown in the first embodiment.

In step S204, the object direction at the transformed position in the real world coordinate system is acquired from the object direction map 202a. The acquired direction in the real world coordinate system is transformed to a direction in the image coordinate system and then outputted to the bottom area calculation unit 203.

In step S205, the bottom area calculation unit 203 calculates bottom areas of the object on the image and the dynamic map, using the 2D-BBOX outputted from the object extraction unit 201 and the direction of the object outputted from the direction calculation unit 202.

The output unit 204 outputs the bottom areas of the object calculated by the bottom area calculation unit 203.

As in the first and second embodiments, it is also possible to calculate the direction of the object without using the object direction map 202a. However, in a case where reliability of the object direction calculated by another method is low, the direction acquired from the object direction map 202a may be used, or only for some detection areas, the direction acquired from the object direction map 202a may be used. Specifically, in a case where the time-series change amount of the 2D-BBOX position is small and is not greater than a predetermined threshold, or in a case where the lane is narrow and the direction of the vehicle is limited, calculation accuracy for the bottom area is higher when the direction acquired from the object direction map 202a in the third embodiment is used as the object direction. Thus, selectively using these methods leads to improvement in object detection accuracy.

Thus, according to the third embodiment, the same effects as in the first embodiment are provided. In addition, the object detection device 200 includes the object direction map 202a, and therefore, in a case where reliability of the object direction calculated by another method is low, the object direction can be complemented using the object direction map 202a. Thus, the bottom area can be calculated with higher accuracy, so that position accuracy of the detected object is improved.

### Fourth Embodiment

Hereinafter, an object detection system and an object detection device according to the fourth embodiment of the present disclosure will be described with reference to the drawings.

The configuration of the object detection system according to the fourth embodiment is the same as that in FIG. 1 in the first embodiment, and the description thereof is omitted.

### <Configuration of Object Detection Device 200>

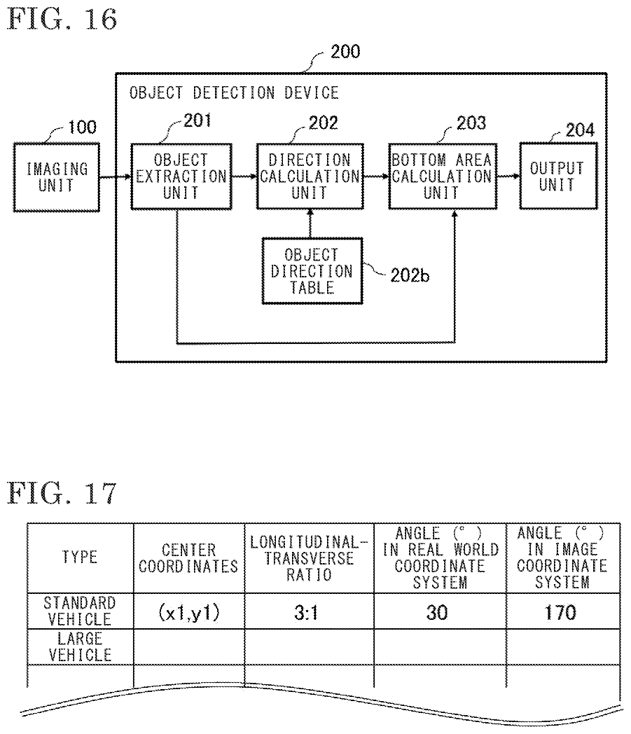

FIG. 16 is a function block diagram showing the object detection device 200 according to the fourth embodiment. In FIG. 16, the object detection device 200 includes an object direction table 202b instead of the object direction map 202a, in the configuration in FIG. 13 in the third embodiment. The direction calculation unit 202 calculates the direction of an object by referring to the object direction table 202b.

The object direction table 202b defines a direction of an object in accordance with the longitudinal-transverse ratio of a 2D-BBOX. As shown in FIGS. 9A and 9B, with respect to the same object, it is assumed that the longitudinal-transverse ratio of the 2D-BBOX changes in accordance with the position and the direction of the object. Therefore, a correspondence relationship of the object direction associated with the type of an object, the position thereof, and the longitudinal-transverse ratio is prepared in advance as a table.

FIG. 17 shows an example of the object direction table 202b. Information about the type, center coordinates in the image coordinate system, the longitudinal-transverse ratio of a 2D-BBOX, an angle in the real world coordinate system, and an angle in the image coordinate system, may be prepared as a table. Here, the table shows an example in which the type is a standard vehicle, the center coordinates in the image coordinate system are (x1, y1), the longitudinal-transverse ratio of the 2D-BBOX is 3:1, the angle in the real world coordinate system is 30°, and the angle in the image coordinate system is 170°. By providing the object direction table 202b as described above, it becomes possible to estimate the object direction even in a case where the object extracted by the object extraction unit 201 is a static object and the time-series history of the 2D-BBOX position cannot be used for direction calculation, for example.

However, even in a case where the bottom area is the same, if the height of the object is changed, the longitudinal width hbbox of the 2D-BBOX is changed, so that the longitudinal-transverse ratio is also changed. Therefore, the above method can be applied only among objects that are the same in width, length, and height. Thus, the above method is effective in a case where it can be assumed that “the sizes of all vehicles are the same in each type”. Specifically, in a case where carriage vehicles in a factory all have the same type number, these vehicles are extracted as objects that are the same in width, length, and height, and therefore the object direction table 202b can be used.

From the longitudinal-transverse ratio, directions (10° and 170°, 60° and 120°, etc.) symmetric with respect to the y axis in the image coordinate system cannot be discriminated from each other, and therefore which direction is the true direction may be separately estimated from the history of the 2D-BBOX position or two kinds of bottom area information may be directly outputted without being discriminated. In a case of estimating the true direction from the history of the 2D-BBOX position, for example, when the longitudinal-transverse ratio is 3:2, the true direction can be determined to be 70° if the 2D-BBOX position moves in an upper-right direction or can be determined to be 110° if the 2D-BBOX position moves in an upper-left direction.

As in the first and second embodiments, it is also possible to calculate the direction of the object without using the object direction table 202b. However, as in the third embodiment, in a case where reliability of the object direction calculated by another method is low, the direction acquired from the object direction table 202b may be used, or only for some detection areas, the direction acquired from the object direction table 202b may be used.

Thus, according to the fourth embodiment, the same effects as in the first embodiment are provided. In addition, the object detection device 200 includes the object direction table 202b, and therefore, in a case where detection targets are objects that are the same in width, length, and height, and reliability of the object direction calculated by another method is low, the object direction can be complemented using the object direction table 202b. Thus, the bottom area can be calculated with higher accuracy, so that position accuracy of the detected object is improved.

The function units of the object detection system 10 and the object detection device 200 in the above first to fourth embodiments are implemented by a hardware configuration exemplified in FIG. 18, which includes a processing circuit 1001, a storage device 1002 including a read only memory (ROM) storing a program for executing the function of each function unit and a random access memory (RAM) for storing data of an execution result of each function unit which is a calculation result by the program, and an input/output circuit 1003.

The input/output circuit 1003 receives image information from the imaging unit 100, and the image information is stored into the storage device 1002. Since an output of the object detection device 200 is used in an automated driving system, the output is sent to an automated driving vehicle or a traffic control system, for example.

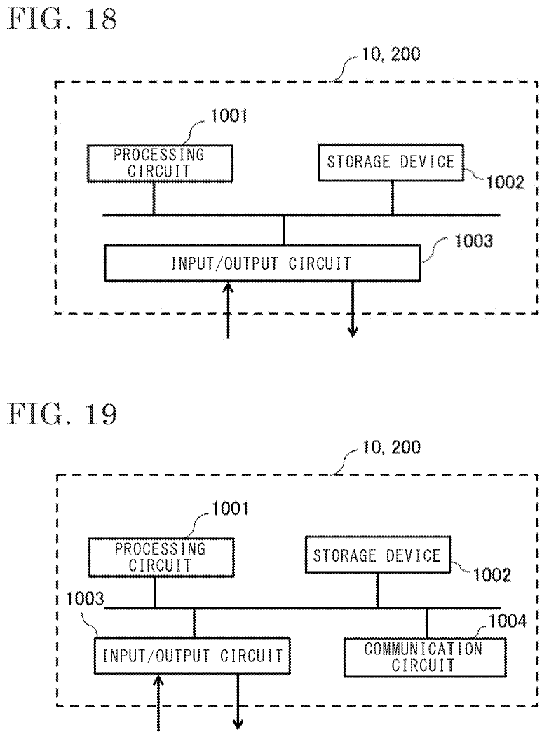

The function units of the object detection system 10 and the object detection device 200 in the above first to fourth embodiments may be implemented by a hardware configuration exemplified in FIG. 19, which further includes a communication circuit 1004 in addition to the configuration shown in FIG. 18. Thus, it becomes possible to pass and receive signals via a wire or wirelessly among the imaging unit 100, the object detection device 200, and the storage unit 300.

The communication circuit 1004 includes, as a communication module, a long-range communication unit and a short-range communication unit, for example. As the long-range communication unit, the one compliant with a predetermined long-range wireless communication standard such as long term evolution (LTE) or fourth/fifth-generation mobile communication system (4G/5G) is used. For the short-range communication unit, for example, dedicated short range communications (DSRC) may be used.

As the processing circuit 1001, a processor such as a central processing unit (CPU) or a digital signal processor (DSP) is used. As the processing circuit 1001, dedicated hardware may be used. In a case where the processing circuit 1001 is dedicated hardware, the processing circuit 1001 is, for example, a single circuit, a complex circuit, a programmed processor, a parallel-programmed processor, an application specific integrated circuit (ASIC), a field-programmable gate array (FPGA), or a combination thereof.

The object detection system 10 and the object detection device 200 may be each implemented by an individual processing circuit, or may be collectively implemented by one processing circuit.

Regarding the function units of the object detection system 10 and the object detection device 200, some of the functions may be implemented by a processing circuit as dedicated hardware, and other functions may be implemented by software, for example. Thus, the functions described above may be implemented by hardware, software, etc., or a combination thereof.

### Other Embodiment

In a case where the object detection system 10 including the object detection device 200 described in the first to fourth embodiments is applied to an automated driving system, an object position can be detected with high accuracy from an image acquired by the road side unit RU and can be reflected in a dynamic map, thus providing an effect that a traveling vehicle can avoid an obstacle in a planned manner.

The automated driving system to which the object detection system 10 and the object detection device 200 are applied as described above is not limited to that for an automobile, and may be used for other various movable bodies. The automated driving system can be used for an automated-traveling movable body such as an in-building movable robot for inspecting the inside of a building, a line inspection robot, or a personal mobility, for example.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

Hereinafter, modes of the present disclosure are summarized as additional notes.

### (Additional Note 1)

An object detection device which extracts an object from an image acquired by an imaging unit and calculates a position of the object in a real world coordinate system, the object detection device comprising:
an object extraction unit which extracts the object from the image and outputs a rectangle enclosing the object in a circumscribing manner;
a direction calculation unit which calculates a direction, on the image, of the object extracted by the object extraction unit; and
a bottom area calculation unit which calculates bottom areas of the object on the image and in the real world coordinate system, using a width of the rectangle outputted from the object extraction unit and the direction of the object on the image calculated by the direction calculation unit, wherein
the bottom areas include positions, sizes, and directions of the object on the image and in the real world coordinate system, respectively.

### (Additional Note 2)

The object detection device according to additional note 1, wherein
the bottom area calculation unit calculates the bottom areas of the object on the image and in the real world coordinate system, further using one of a width of the object, a length thereof, and a ratio of the width and the length in the real world coordinate system.

### (Additional Note 3)

The object detection device according to additional note 2, wherein
the object extraction unit includes a type determination unit for determining a type of the extracted object, and outputs the type of the object determined by the type determination unit, as well as outputting the rectangle enclosing the object in the circumscribing manner, and
the bottom area calculation unit calculates the bottom areas of the object on the image and in the real world coordinate system, using one of the width of the object, the length thereof, and the ratio of the width and the length in the real world coordinate system on the basis of the type of the object determined by the type determination unit.

### (Additional Note 4)

The object detection device according to any one of additional notes 1 to 3, further comprising an object direction map in which an object direction is defined in accordance with a position in the real world coordinate system, wherein
the direction calculation unit calculates the direction, on the image, of the object extracted by the object extraction unit, using the object direction map.

### (Additional Note 5)

The object detection device according to any one of additional notes 1 to 3, further comprising an object direction table in which directions on the image and in the real world coordinate system are defined in accordance with a longitudinal-transverse ratio of the rectangle, wherein
the direction calculation unit calculates the direction, on the image, of the object extracted by the object extraction unit, using the object direction table.

### (Additional Note 6)

An object detection system comprising:
the object detection device according to any one of additional notes 1 to 5; and
the imaging unit.

### (Additional Note 7)

The object detection system according to additional note 6, wherein
the imaging unit includes a road side unit provided with a camera.

### DESCRIPTION OF THE REFERENCE CHARACTERS

10 object detection system
100 imaging unit
200 object detection device
201 object extraction unit
201a type determination unit
202 direction calculation unit
202a object direction map
202b object direction table
203 bottom area calculation unit
204 output unit
300 storage unit
1001 processing circuit
1002 storage device
1003 input/output circuit
1004 communication circuit
BAp, BAw, BAp1, BAp2 bottom area
RU road side unit
VE1, VE2 vehicle

What is claimed is:

1. An object detection device which extracts an object from an image acquired by an imaging device and calculates a position of the object in a real world coordinate system, the object detection device comprising:
an object extraction circuitry which extracts the object from the image and outputs a rectangle enclosing the object in a circumscribing manner;
a direction calculation circuitry which calculates a direction, on the image, of the object extracted by the object extraction circuitry; and
a bottom area calculation circuitry which calculates bottom areas of the object on the image and in the real world coordinate system, using a width of the rectangle outputted from the object extraction circuitry and the direction of the object on the image calculated by the direction calculation circuitry, wherein
the bottom areas include positions, sizes, and directions of the object on the image and in the real world coordinate system, respectively.

2. The object detection device according to claim 1, wherein
the bottom area calculation circuitry calculates the bottom areas of the object on the image and in the real world coordinate system, further using one of a width of the object, a length thereof, and a ratio of the width and the length in the real world coordinate system.

3. The object detection device according to claim 2, wherein
the object extraction circuitry includes a type determination circuitry for determining a type of the extracted object, and outputs the type of the object determined by the type determination circuitry, as well as outputting the rectangle enclosing the object in the circumscribing manner, and
the bottom area calculation circuitry calculates the bottom areas of the object on the image and in the real world coordinate system, using one of the width of the object, the length thereof, and the ratio of the width and the length in the real world coordinate system on the basis of the type of the object determined by the type determination circuitry.

4. The object detection device according to claim 1, further comprising an object direction map in which an object direction is defined in accordance with a position in the real world coordinate system, wherein
the direction calculation circuitry calculates the direction, on the image, of the object extracted by the object extraction circuitry, using the object direction map.

5. The object detection device according to claim 1, further comprising an object direction table in which directions on the image and in the real world coordinate system are defined in accordance with a longitudinal-transverse ratio of the rectangle, wherein
the direction calculation circuitry calculates the direction, on the image, of the object extracted by the object extraction circuitry, using the object direction table.

6. An object detection system comprising:
the object detection device according to claim 1; and
the imaging device.

7. The object detection system according to claim 6, wherein
the imaging device includes a road side device provided with a camera.

8. An object detection system comprising:
the object detection device according to claim 2; and
the imaging device.

9. The object detection system according to claim 8, wherein
the imaging device includes a road side device provided with a camera.

10. An object detection system comprising:
the object detection device according to claim 3; and
the imaging device.

11. The object detection system according to claim 10, wherein
the imaging device includes a road side device provided with a camera.

12. An object detection system comprising:
the object detection device according to claim 4; and
the imaging device.

13. The object detection system according to claim 12, wherein
the imaging device includes a road side device provided with a camera.

14. An object detection system comprising:
the object detection device according to claim 5; and
the imaging device.

15. The object detection system according to claim 14, wherein
the imaging device includes a road side device provided with a camera.
